(19) United States
(12) Patent Application Publication
(10) Pub. No.: US 2002/0137472 A1
(43) Pub. Date: Sep. 26, 2002

(54) Wireless antenna switching system

(76) Inventors: Liam B. Quinn, Austin, TX (US); Alan Eric Sicher, Austin, TX (US)

Correspondence Address: Emmanuel A. Rivera, SKJERVEN MORRIL MacPHERSON LLP, 25 Metro Drive, Suite 700, San Jose, CA, 95110-1349, US

(21) Appl. No.: 09/768,072

(22) Filed: Jan. 23, 2001

(51) Int. Cl. H04B 1/38

(52) U.S. Cl. 455/90; 455/102; 455/132; 455/557

(57) ABSTRACT

A switching system to multiple transceivers in a mobile computing system allows communication through various technologies, namely belonging to WWAN, WLAN, and WPAN space. A common antenna or antennas is shared by the transceivers. The switching system connects the proper transceiver to the antenna system and communication priority to and from the computer system is given to the chosen transceiver. The transceivers are placed on a Mini PCI card or similar factor form and interface directly to the computing system. Transceiver priority may be chosen by a particular application or when communication is being sent to the system, the proper transceiver may be chosen to receive the communicated signals.

### BACKGROUND OF THE INVENTION

1. Field of the Invention

This invention relates to a computer system, and more particularly to a mobile computing system or platform using an antenna system capable of supporting multiple antenna standards and various transmission and reception formats.

2. Description of the Related Art

Mobile personal computers (PC), also known as “laptops” and “notebooks” (notebook), typically provide wireless communications by the use of what are commonly known as PC cards defined by the Personal Computer Memory Card International Association (PCMCIA). A PC card is a self-contained device that may have a battery, random access memory (RAM), read only memory (ROM) and application specific circuitry. In typical applications, a PC card used for wireless communication will use an antenna interface to establish a wireless connection to a remote terminal or access point.

Certain wireless communication PC cards have built in antennas that protrude out the card. These integrated antennas are designed exclusively for the wireless technology used by that particular PC card.

Wireless communications, mobile computing platforms or PCs may be extended to support wireless personal area networks (WPAN); wireless local area networks (WLAN); and wireless wide area networks (WWAN).

WPAN is an evolving area that includes an industry driven specification known as “Bluetooth,” which is used as the basis for Institute of Electrical and Electronics Engineers (IEEE) standard 802.15. WPANs address wireless networking of portable and mobile computing devices such as PCs, Personal Digital Assistants (PDAs), peripherals, cell phones, pagers, and consumer electronics; allowing these devices to communicate and operate with one another. The Bluetooth specification and proposed IEEE 802.15 standard are specifically targeted as cable replacement wireless technologies for a range of diverse computing devices.

Since wireless communication covers a broad spectrum of technology and is very fragmented, PC cards tend to be device specific to a particular industry standard communication protocol or application. Depending on the wireless solution that is sought, a particular PC card is chosen. A wireless PC card is typically specific to a particular wireless technology such as cellular, Bluetooth, or WLAN. For example, a PC card which supports code division multiple access (CDMA) technology for cellular communication cannot support WLAN such as IEEE standard 802.11b or Bluetooth WPAN.

A notebook user relying on PC card technology must choose which type of communications is desired, for example technology related to WLAN, WWAN, or WPAN. A PC card user with usage requirements in WWAN space and in WLAN space may find the need to use two separate PC cards. With multiple wireless communication applications simultaneously being used and PC card slot space limited, a user may be required to switch cards, prioritizing the wireless application that is desired and foregoing other applications. Integrating multiple wireless transceivers that support multiple communication technologies onto a PC card can be cost prohibitive and or have design constraints.

Integrating multiple wireless technologies and an arrangement that continuously switches between transceivers on a card bus add significant cost and introduce technical problems.

The clear delineation of the different wireless technologies today will be less obvious over time as technological integration of hardware and software enables the migration towards flexible software configurable solutions or applications.

Wireless technology is also beginning to overlap in the frequency spectrum that is being used, therefore antennas are now more readily able to support various communication technologies. Now referring to FIG. 1 illustrated is a chart of wireless communication technologies and their typical operating frequencies. Wireless communications can be grouped under communication category 10, further categorized as communication technology 15 and further defined by operating frequency band 20. In the industry WWAN 25 includes general packet radio service (GPRS) 40 that may operate at a channel frequency of 900/1800 megahertz (MHz) or 1900 Mhz; code division multiple access (CDMA) 45 that operates at 850/1900 MHz; time division multiple access (TDMA) 50 operating at 850/1900 MHz; and wideband CDMA (W-CDMA) 55 operating at 2.0 gigahertz (GHz). The WLAN 30 category includes IEEE standard 802.11b 60 operating at 2.4 GHz and IEEE 802.11a 65 operating at 5.2 GHz. In WPAN 35, Bluetooth 70 technology operates at 2.4 GHz. WPAN also includes the evolving IEEE standard 802.1575 at 2.4 GHz. This standard may potentially operate at a different frequency in the future.

Current antennas now have the capability to support a wider range of frequencies, and support communication of multiple technologies. Antenna systems include diversity receive systems which cover both spatial and polarization diversity. PC manufacturers have also found that antennas may be physically integrated into the notebook chassis, thus reducing and or eliminating the need for an external or protruding antenna outside of the notebook. Examples of antennas that may be used include Rangestar Wireless, Inc.'s “US Dual Band+Bluetooth” model #100704 and “EUR Dual Band +Bluetooth” model #100702.

To provide additional wireless communication solutions, notebook manufacturers have also integrated wireless devices or controllers into notebooks. Modems supporting wireless communications can be integrated onto motherboards or daughter cards of located inside the notebooks. Instead of a user having to install a PC card controller, the controller is already integrated into the notebook. Integration of wireless devices directly into a computer system, however, ties a notebook to a particular wireless solution. In the challenge of releasing new notebooks onto a competitive marketplace, certification of a wireless device that is integrated into the notebook delays delivery of the notebook into the marketplace. This becomes especially problematic when the same notebook is sold in the United States, Europe, and Asia where different wireless standards may exist in the three markets.

To address the problems of integrating wireless solutions, and to integrate other “peripheral” applications into a notebook, manufacturers have looked to a standard form factor. To this end, the peripheral component interconnect special interest group (PCI SIG) developed the Mini PCI form factor.

Mini PCI for wireless communications peripherals for notebooks offers several benefits over existing custom embedded solutions (motherboard or daughter card solutions) and PC cards. Based on the PCI bus interface, Mini PCI is flexible and offers economies of scale especially when notebooks are “built to order.” The Mini PCI card is a small compact card specification, functionally equivalent to a standard PCI expansion card, with a standard 32-bit PCI local bus, standard PCI basic input output system (BIOS)/driver interface, and standard input and output (I/O). Since Mini PCI is based on the existing PCI bus used by the notebook, operating system applications will not be able to differentiate between a Mini PCI card and a device located in or on a PCI bus.

Applications for Mini-PCI cards, however, have been limited to specific wireless communications such as are available to PC cards. In part these limitations are due to the level of silicon or process maturity and feature set integration for these cards. Different wireless standards are evolving over time and will eventually migrate to form factors supported by Mini-PCI and similar form factors such as compact flash cards, based on chipset integration readiness/levels, power, size and cost.

Notebook users will need a diverse, if not complete, wireless communication capability. To provide wireless communication in the WWAN, WLAN, and WPAN space, a notebook must support multiple transceivers.

A notebook should have the ability to dynamically adapt and connect to the optimal wireless network. The connection should seamlessly detect and connect to the transceiver that contains the appropriate wireless communication technology.

### SUMMARY OF THE INVENTION

In a mobile computing system that communicates in various wireless communication technologies, multiple transceivers are provided.

These multiple transceivers that support various wireless technology protocols are interfaced to a switching system, the switching system interfaces to an antenna or antennas that are able to receive and transmit and support the multiple transceivers.

The selection of the right transceiver may be implemented by detecting power that is transmitted, since WWAN, WLAN, and WPAN technologies have varying transmission power requirements, with WWAN having the greatest transmission power. To detect power transmission a zener diode based network may be used, or other means such as sensing logic may be incorporated. Current limiter devices may also be used.

The invention provides for a state information table in which the transceivers send information upon system start up (initialization) or boot-up. The state information is used by the PC basic input/output system (BIOS) to determine the transceiver in control, and enable the appropriate transceiver radio/antenna logic.

The invention makes use of a separate card form factor for the transceivers so that the transceivers can be certified separate from the computer system providing radio frequency electromagnetic interference (RF/EMI) regulatory independence from the PC system.

### BRIEF DESCRIPTION OF THE DRAWINGS

The present invention may be better understood, and it's numerous objects, features and advantages made apparent to those skilled in the art by referencing the accompanying drawings. The use of the same reference number throughout the figures designates a like or similar element.

FIG. 1 illustrates frequency space of wireless communication technology.

FIG. 2 illustrates a top-level block diagram of multiple transceivers switched to an antenna system.

FIG. 3 illustrates a chipset block diagram of a transceiver device.

FIG. 4A illustrates Mini PCI form factor I.

FIG. 4B illustrates Mini PCI form factor II.

FIG. 4C illustrates Mini PCI form factor III

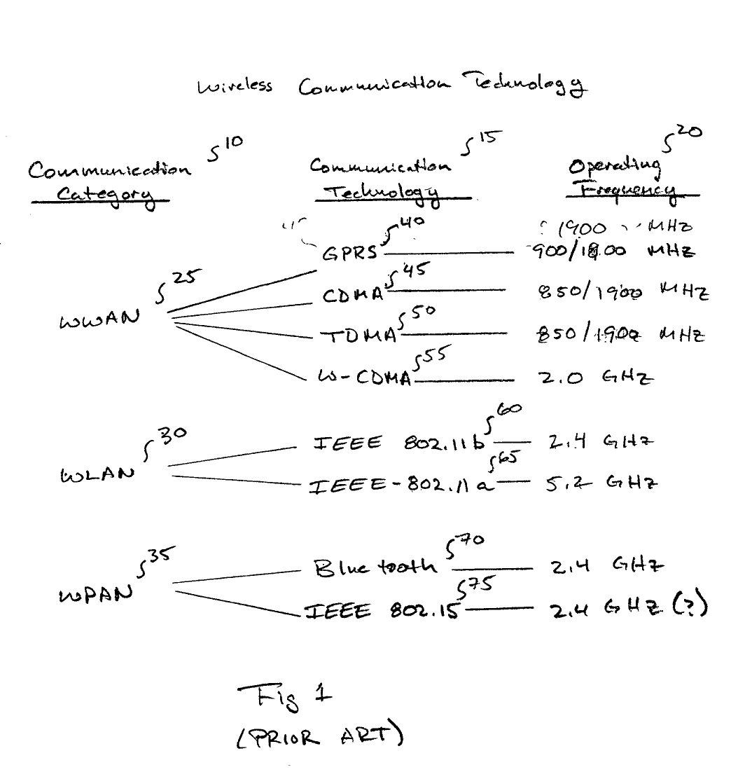

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the spirit and scope of the present invention as defined by the appended claims.

### DETAILED DESCRIPTION

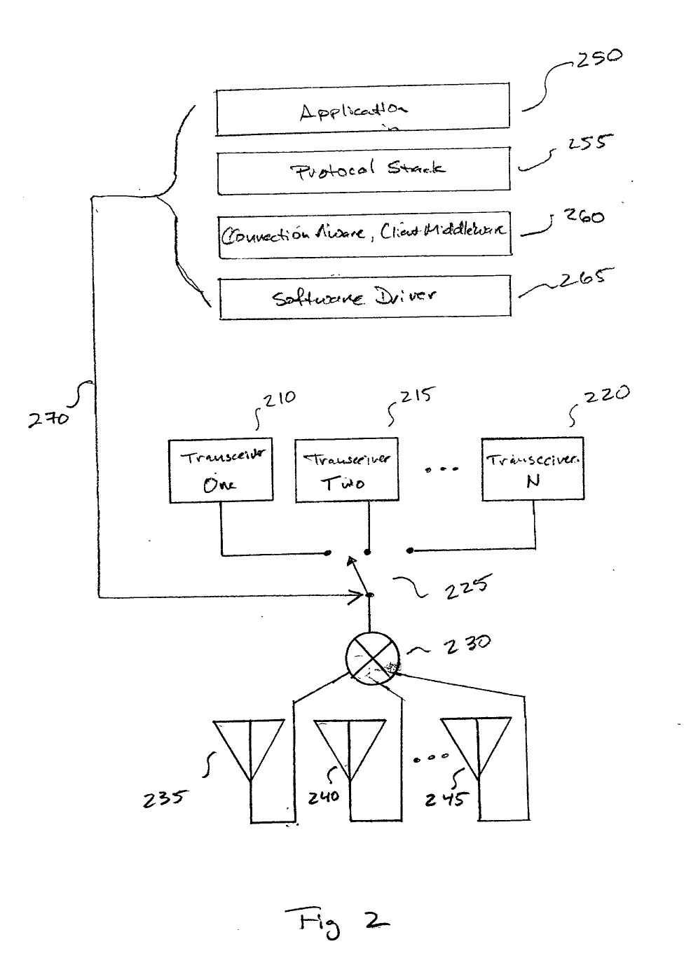

Now referring to FIG. 2, illustrated is a block diagram of a wireless communication system capable of switching between multiple transceiver cards. The communication system consists of multiple transceiver boards that support various wireless communication technologies. In one embodiment the transceiver boards support three various types of technologies, namely WWAN, WLAN, and WPAN technologies.

Transceiver One 210 support can be a WWAN, a WLAN, or a WPAN device. Transceiver One 210 can also be a combination device that can support multiple technologies covering WWAN, WLAN, and WPAN. Likewise transceiver two 215 and transceiver N 220 can support one or various wireless technologies. Additional transceivers may also be added to the communication system. Transceiver One 210, transceiver Two 215, transceiver N 220, and any other transceiver are selectively connected to a selector 225. The selector 225 is a switch that chooses the correct transceiver depending on the wireless application or technology that is required or chosen. The selected transceiver can directly communicate to the PC system. Selector 225 actively switches and enables and disables connection to the antenna system. The antenna system as illustrated in FIG. 2 may consist of one or more antennas. Transceiver One 210, Transceiver Two 215, and other transceivers including Transceiver N 220 all have a direct connection to the PC system. The ability to receive will depend if selector 225 chooses a particular receiver. Communication to the user is transparent (uninterrupted) since the selector is continuously and actively switching between transceivers. If the transceivers are placed on a Mini PCI card, the connection of a transceiver to the computer (PC) system would be through the Mini PCI connector to the computer system.

The selector 225 is connected to an antenna system by an antenna connector 230. Connector 230 connects one or more antennas to the selector 225. An antenna system includes antenna 235, antenna 240, antenna 245, and or additional antennas that support various required frequencies and transmission technologies required of the multiple transceivers. Alternatively if possible, the multiple antennas may be combined into one single antenna if such an antenna is capable of supporting the multiple transceivers.

Transceiver Selection

An external control signal can directly come from an application but some sort of state information can be sent to the selector 225 advising the selector 225 to switch to a particular transceiver. When a transceiver is fired up by a software application, the application directs it over to computer system interface. When a transceiver is directly activated state information is sent to selector 225 and selector 225 handles contention between the transceivers. In the unlikely event that more than one transceiver is activated at the time, a prearranged preference is referred to.

Transceiver preference may be set through a direct software application interfaced with the selector 225 coming down the operating system through software drivers. Passive power detection may be made at the selector 225. Alternatively, preference may be made if the transceivers are active and state information is provided back to the computer system.

Transmission power is proportional to distance transmitted therefore switch 225 that controls multiple transceiver boards to an antenna can switch depending on the power that is transmitted. Table 1 illustrates wireless technology and transmitting power. WPAN communicates within a relatively short distance, about 10 meters and requires a relatively lower transmitting power. WLAN communicates at a distance greater than 100 meters and requires a little more transmitting power. WWAN communicates at distances greater than 1000 meters and requires even greater transmission power. If in a particular embodiment Transceiver One 210 is a WPAN transceiver, Transceiver Two 215 is a WLAN transceiver, and Transceiver N 220 is a WWAN transceiver, selector 225 can be set up to detect power transmission or reception power and connect the appropriate transceiver.

Power detection may be made during transmission or reception. When a particular application transmits communication the proper transceiver is chosen by the power that is being used to transmit. Alternatively, the particular transceiver may be chosen by the amount of power that is being received on a particular channel. The power received correlates with a particular wireless communication technology and a particular receiver in the notebook.

Power detection can be made using a number of methods. One application may make use of a zener diode circuit with a threshold voltage/power limit set to a particular voltage level. Another method can be based on the current drawn, to detect the presence, use of a particular antenna, or device in the system. Power sensors may be incorporated to detect and compare reference voltages. Power values can be compared and depending on the given reference values, the appropriate transceiver can be selected.

TABLE 1

| Technology | Distance | Transmitting Power (watts) |
|---|---|---|
| WPAN | 10 meters | 0.001 to 0.010 |
| WLAN | >100 meters | 0.010 to 0.100 |
| WWAN | >1000 meters | 0.100 to 2.00 |

Lookup tables or comparison charts that relate the transceivers with appropriate antennas can also be used. In one application a user connects to the Internet or a corporate network, that connection could be predefined to involve WWAN. Software that relates to and supports WWAN applications would deduce that WWAN connectivity is needed and the appropriate transceiver will be selected.

Additional scenarios can include WPAN connection to a personal digital assistant (PDA). This type of connection would require short range. For example if a user is using an application such as Microsoft Outlook® and the user desires to send an electronic card, calendar appointment, or electronic business card, short range or WPAN technology such as Bluetooth would be needed. The Microsoft Outlook® would instruct another software application program to switch to the WPAN capable transceiver.

Other application driven examples include a search on type of communication technology as controlled by a predetermined preference or algorithm. If the technology is not detected or system attach fails then the notebook will switch over and hunt for a secondary (2nd preferred) type of technology. This could be based on a predetermined priority order starting with a device/interface that has the lowest power.

Another application driven search and selection includes lowest costs (no airtime charges), and shortest range (scaling upwards until a reliable connection is established). The goal is to provide wireless connectivity anywhere, anytime regardless of the underlying hardware transport, or the mode/environment where the user uses the platform.

Now referring back to FIG. 2, illustrated is an application block 250, protocol stack block 255, client middle-ware block 260, and software driver block 265 that logically interfaces to the selector 225 via an interface 270. This logical interface can be made through a number of methods including an interface through the computer's operating system.

The interface to an operating system stack can be made in a number of ways. One way would be to interface at the software driver level. A software driver can interface with the operating system and the software driver is able to control the interface to multiple types of transceivers. A single software driver that interfaces the operating system is able to address the transceivers and can incorporate logic that instructs when to use which transceiver.

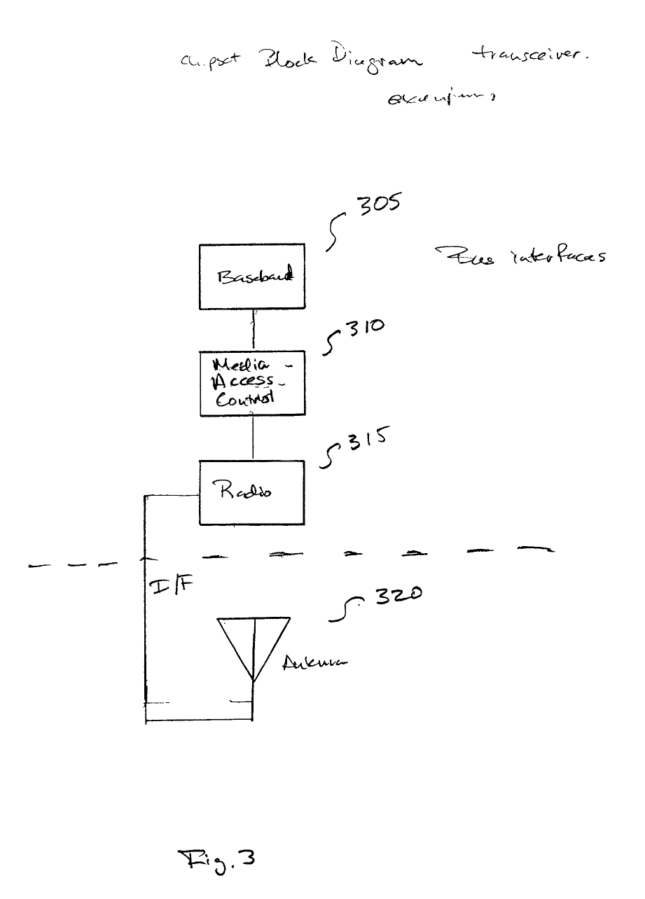

Now referring to FIG. 3 illustrated is a logical block diagram of a transceiver device. Base-band block 305 provides interfaces to computer system busses. Base-band block interfaces to a media access controller (MAC) 310. The MAC 310 interfaces to a radio device 315, the radio device in turn interfaces to an antenna system 320.

The MAC 310 is also known as an adapter driver. The MAC 310 driver controls the network adapter hardware, which provides electronic connectivity through a cable or other media to other computers. The MAC driver moves frames between the protocol stack and the adapter hardware.

The MAC 310 device driver contains the details of network interface cards (NIC) in such a way that all NICs for the same media (e.g. ethernet) can be accessed using a common programming interface. Since control of the transceivers can be performed within the driver software, control is through the network driver interface specification (NDIS) layer. NDIS defines a standard application programming interface (API) for NICs. NDIS provides a library of functions, sometimes called a “wrapper,” that can be used by the MAC 310 drivers as well as higher level protocol drivers. An API is a series of functions that application programs can use to make the operating system do redundant tasks. Using APIs, an application program can open windows, files, and message boxes—as well as perform more complicated tasks—by passing a single instruction.

The operating system (OS) is made largely transparent to the inter-working of multiple communications protocols and transceivers. A single NDIS driver interface can be used for multiple transceivers. The NDIS driver manages the transceiver and antenna switching. This can be achieved in a number of ways such as adding an interoperability software stack driver in the OS, or through a management API, or a basis management graphic user interface (GUI).

There are many distinct software components, or modules, in a computer system. Several software modules are needed to allow the computer to use a network. Each module provides a specific function, such as controlling the adapter hardware, or guaranteeing that data is sent and received properly between computers, or helping the user to access remote computers as if they were local.

NDIS describes a common boundary between software modules which provide communication services to a computer, thereby allowing the computer to share information with other computers. Software modules of particular note for this invention that are described by NDIS are modules related to the protocol stack and the protocol manager. The protocol stack is a collection of modules which provides reliable network communications. A stack produces and consumes frames, frames control information and data, which are sent to and received from the network. The protocol manager assists the protocol stack(s) and MAC 310 to cooperate.

Form Factor

It is contemplated that the transceiver system can be designed into a Mini PCI card or other hybrid form factor—the form factor will be dependant on the user implementation. The antenna system can also be designed into the Mini PCI card or other hybrid form factor, however, the antenna system may be an integrated part of the computer system, and an interface to the antennas from the Mini PCI transceiver card can be provided.

Depending on the needs of a specific market, the Mini PCI card or hybrid card can be designed to accommodate transceivers applicable to the specific market. For example a notebook system in the United States can use a Mini PCI card that supports WWAN, WLAN, and WPAN technologies in the United States. The same notebook can use a different Mini PCI card in Europe which may have a different wireless standard(s). Further a particular Mini PCI card is not limited to a particular computer system and can support various notebook PCs. Verification and certification of the form factor card and the notebook can take place independent of one another.

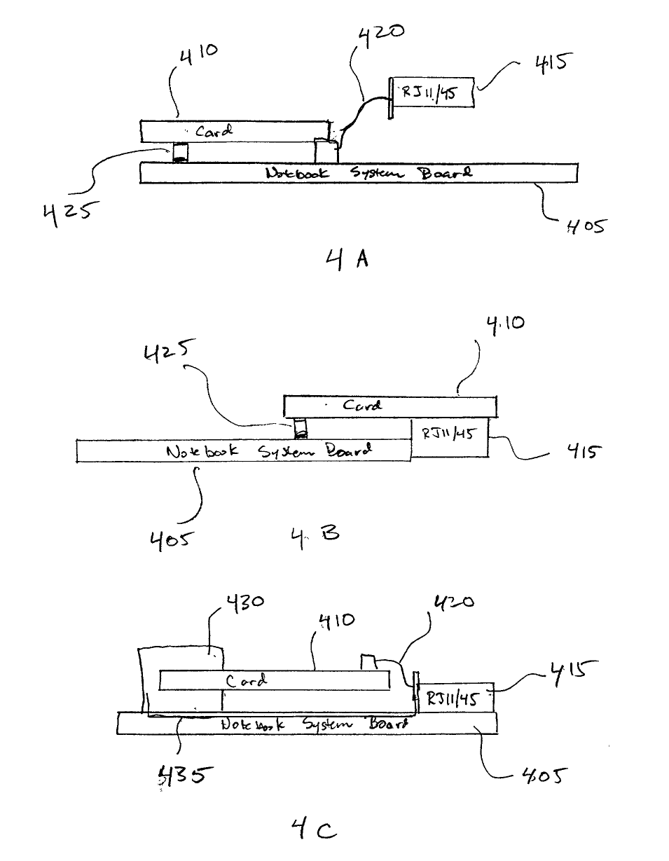

A multiple transceiver system may be integrated into a card such as a Mini-PCI card. The way the card interfaces to notebook system may depend on the design goals for the notebook. Now referring to FIG. 4A, illustrated is a Mini PCI form factor that focuses on full featured notebook systems. Card 410 uses a stacking connector 425 to interface to the notebook system board 405. Registered jack (RJ)-11 is a four or six wire connector used to connect to telephone equipment. RJ-45 connect is an eight wire connector used to connect computers to LANs, in particular Ethernets. A provision is made so that an RJ11 or RJ45 connector 415 is connected by a twisted pair cable, flexible circuit or similar connection 420 to the card 410. In this particular embodiment card 410 is a Mini PCI form factor, however, other card form factors can be used. Due in part to the flexible connection 420, the setup in FIG. 4A allows for flexibility in placement of devices in particular the RJ-11 or RJ45 connector. The RJ-11 or RJ-45 connector then can be connected to a modem and or an antenna system. Particular embodiments of a notebook system will place the antenna(s) within the chassis of the notebook.

An RJ-11 or RJ-45 connector may be directly integrated onto the card to lower production cost. Now referring to FIG. 4B illustrated is a Mini PCI form factor that focuses on lower cost notebook systems. Card 410 connects to the notebook system board by a stacking connector 425. The RJ-11 or RJ-45 connector 415 is directly connected the card 410. This particular setup is designed to lower cost by using an-board RJ-11 or RJ-45 connector 414, however, flexibility in placing the card 420 is limited. The RJ-11 or RJ-45 connector is connected to a modem and or an antenna system.

For thin notebook systems a different connection system may be employed. Now referring to FIG. 4C, illustrated is a Mini PCI form factor that focuses on thin systems. A small outline dual in-line memory module (SO-DIMM) edge connector 430 interfaces the card 410 to the notebook system board 405. The use of the SO-DIMM edge connector 430 allows for a thinner profile. A twisted pair cable or flexible circuit 420 connects an RJ-11 or RJ-45 connector 415 to the card 410. The RJ-11 or RJ-45 connector is connected to a modem and or an antenna system. An alternative connection may be provided having a trace line 435 integrated into the notebook system board 405. The trace line 435 runs along the notebook system board 435 to the SO-DIMM connector 430.

Although the Mini PCI card form factor is described, other card form factor can be used. Other alternatives include use of a PCMCIA card slot; an indirect interface through Mini PCI card slot by way of the north or south bridge controllers of the PC system; compact flash cards; or an internal universal serial bus (USB) peripheral.

Although the present invention has been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

What is claimed is:

1. A portable computing system with selectable transceiver switching comprising:
a set of one or more transceivers, each of the transceivers with a unique communication protocol;
a switch capable of differentiating communication signals and determining and choosing an appropriate transceiver from the set of transceivers to communicate for the computing system; and
a multi-band antenna capable of receiving and transmitting varying frequency signals to the chosen transceiver.

2. The portable computing system of claim 1 wherein the switch is a zener diode that differentiates upon power transmission.

3. The portable computer system of claim 1 wherein the switch is an active power sensor device.

4. The portable computer system of claim 1 wherein the switch is a current limiter device.

5. The portable computer system of claim 1 further comprising:
a lookup table that associates transmission power with each of the transceivers, whereby the switch selects a transceiver from the set of transceivers when a certain power state in the lookup table is detected.

6. The portable computer system of claim 5 wherein the switch selects a transceiver based on a transmitted power.

7. The portable computer system of claim 5 wherein the switch selects a transceiver based on a received power.

8. The portable computer system of claim 1 further comprising:
a software driver that interfaces to the transceiver and interfaces to an operating system of the portable computer system, whereby the software driver receives instructions as to which transceiver of the set of transceivers to select.

9. The portable computer system of claim 8 wherein the software driver receives instructions from a higher level protocol stack of the portable computer system.

10. The portable computer system of claim 8 wherein the software driver receives instructions from a set of software applications of the portable computer system.

11. The portable computer system of claim 1 wherein the set of transceivers and the switch are integrated into a circuit card.

12. The portable computer system of claim 7 wherein the circuit card connects to a system board of the portable computer system.

13. The portable computer system of claim 7 wherein the circuit card is a Mini PCI card.

14. A method of switching between a set of one or more transceivers within a portable computing system comprising:
looking up in a state table corresponding power and frequency values;
comparing the power and frequency of a received signal to the corresponding power and frequency value; and
selecting a transceiver board capable of processing the received signal.

15. A method of switching between a set of one or more transceivers within a portable computing system comprising:
looking up in a state table corresponding power and frequency values;
comparing the power and frequency of a transmitted signal to the corresponding power and frequency value; and
selecting a transceiver board capable of processing the received signal.

16. The method of switching between a set of one or more transceivers within a portable computing system of claim 14 wherein:
selection of a transceiver is performed by a software driver.

17. The method of switching between a set of one or more transceivers within a portable computing system of claim 16 wherein:
the software driver is instructed by a higher level protocol stack.

18. The method of switching between a set of one or more transceivers within a portable computing system of claim 14 wherein:
the software driver is instructed by a set of software applications of the portable computer system.

19. The method of switching between a set of one or more transceivers within a portable computing system of claim 15 wherein:
selection of a transceiver is performed by a software driver.

20. The method of switching between a set of one or more transceivers within a portable computing system of claim 19 wherein:
the software driver is instructed by a higher level protocol stack.

21. The method of switching between a set of one or more transceivers within a portable computing system of claim 19 wherein:
the software driver is instructed by a set of software applications of the portable computer system.
